(19) United States
(12) Patent Application Publication
(10) Pub. No.: US 2006/0059783 A1
(43) Pub. Date: Mar. 23, 2006

(54) Sliding door for a motor vehicle

(75) Inventors: Thomas Braun, Ennepetal (DE); Daniela Bender, Wuppertal (DE); Michael Langfermann, Wuppertal (DE); Ralf Hacklaender, Remscheid (DE); Michael-Michael Gampe, Velbert (DE); Markus Kothe, Velbert (DE)

Correspondence Address: ROBERTS, MLOTKOWSKI & HOBBES, P. O. BOX 10064, MCLEAN, VA, 22102, US

(73) Assignee: Brose Schliesssysteme GmbH & Co. KG, Wuppertal (DE)

(21) Appl. No.: 11/180,618

(22) Filed: Jul. 14, 2005

(30) Foreign Application Priority Data
Jul. 15, 2004 (DE) 10 2004 034 509.0

(51) Int. Cl. E05F 11/00

(52) U.S. Cl. 49/360

(57) ABSTRACT

A sliding door for a motor vehicle, the sliding door being movable by a sliding motion into an opened and into a closed position, and having a fixing arrangement (2). The fixing arrangement (2) has an engagement module (3) and an engagement element (4), the engagement module (3) engaging the engagement element (4) when the sliding door is moved into the opened position and in this way fixing the sliding door in the opened position. It is proposed that the engagement module (3), when the sliding door has been fixed in the opened position, can be actuated by a drive in a motorized manner so that, in this way, the engagement element (4) is released and the sliding door can then be moved in the closing direction.

### BACKGROUND OF THE INVENTION

1. Field of Invention

This invention relates to a sliding door for a motor vehicle, the sliding door being movable by a sliding motion into an opened and into a closed position, there being a fixing arrangement having an engagement module and an engagement element, the engagement module engaging the engagement element when the sliding door is moved into the opened position and in this way fixes the sliding door in the opened position.

2. Description of Related Art

Here, the term “sliding door” encompasses all components which are necessary for the functionality of a sliding door. They include, in addition to the sliding component, also the corresponding frame which is provided in the motor vehicle body, guide rails which may be present, etc. The term “sliding door” is used below synonymously with the term “sliding component” whenever it promotes readability.

Sliding doors have been used for a long time for delivery trucks and vans, more recently to an increasing degree for passenger cars. It is common to all sliding doors that they can be moved by a sliding motion into an opened position and into a closed position. This sliding motion takes place essentially parallel to the side wall of the vehicle. That undisrupted loading and unloading or getting in and out is possible is especially advantageous.

Numerous versions are known for the structural implementation of the kinematics of motion of a sliding door. This includes, for example, the principle of rail guidance to which, if necessary, a lever arrangement is added. The special constructional implementation of the dynamics of motion is not what is important here. Rather, the approach of the invention can be applied to all conceivable designs. Nor is it critical here where the sliding door is located on the motor vehicle, so that sliding doors which are located both to the side and also to the rear on the motor vehicle are encompassed.

One basic requirement for sliding doors for motor vehicles is that the sliding door remains in its opened position and does not automatically slam shut during loading and unloading or when getting in and out. This applies especially when the motor vehicle is on an incline such that the weight of the sliding door presses in the closing direction.

One possibility for preventing unwanted, automatic closing is shown by the known sliding door underlying this invention (German Patent Application DE 23 47 702 A1). It is a rail-guided sliding door which has a fixing arrangement for fixing the sliding door in the opened position. The fixing arrangement is provided with a pivoting journal which is located on the sliding component of the sliding door and which, when the sliding door is moved into the open position, engages a hook-shaped recess, and thus, prevents the sliding door from moving backward.

In the known sliding door, especially when the motor vehicle is inclined, a major expenditure of force is necessary to actuate the fixing arrangement, therefore to lift the journal out of the hook-shaped recess. This leads to a major loss of operating ease.

Another known sliding door (U.S. Pat. No. 6,134,837 A) can be moved by a motor and has a fixing arrangement which is based on the self-locking action of the drive on the sliding door. Here, there is a clutch means which, on the one hand, also enables manual actuation, and on the other hand, prevents the unwanted automatic closing of the sliding door. Aside from the fact that this approach can be applied solely to a sliding door which can be moved by a motor, it leads to considerable control engineering effort.

### SUMMARY OF THE INVENTION

A primary object of this invention is to embody and develop the known sliding door for a motor vehicle such that the ease of operation is enhanced with simple means.

This object is achieved by a sliding door for a motor vehicle of the initially mentioned type by the engagement module, when the sliding door has been fixed in the opened position, being actuatable by a drive in a motorized manner. In this way, the engagement element can be released and the sliding door can then be moved in the closing direction.

What is important is the engagement module of the fixing arrangement being provided with the ability to be actuated by a motor. In this way, it is possible to reduce the actuation of the engagement module to the actuation of an electrical switch or to the actuation of a remote control. Actuation of the engagement module by the operator is thus associated with a minimum expenditure of force.

In one preferred configuration, it is provided that the closing principle known from the field of motor vehicle door locks with latch, ratchet and engagement element is also used for the fixing arrangement of the sliding door. This is advantageous, provided that the latch and ratchet can be easily designed such that lifting of the ratchet is possible with minimum expenditure of force. This leads to an advantageous design of the drive.

Furthermore, it should be emphasized that the engagement of the ratchet, and thus, blocking of the latch are ensured even in vigorous opening of the sliding door. The ratchet can be easily designed such that even with extremely high-speed rebound of the sliding door, an adequate engagement speed is ensured.

Additionally, it has been recognized that, in the proposed approach, unwanted release of the sliding door is only possible when the ratchet has been lifted. The case of a fault in which the ratchet moves “by itself” into the raised position is hardly conceivable. The aforementioned relative movements between the sliding component of the sliding door, on the one hand, and the motor vehicle body, on the other, cannot lead to such a fault in any case, since these relative movements take place exclusively between the latch and the engagement element.

Another preferred configuration leads to an especially compact arrangement, since the fixing arrangement is assigned at least partially to the motor vehicle lock arrangement. The fixing arrangement makes possible, for example, an additional lock arrangement at the same time for support of the main lock arrangement.

For the above described multiple use of the fixing arrangement, in one especially advantageous configuration of the latch of the engagement module which in turn leads to an especially compact arrangement, the latch has a first fork-shaped recess for engaging the first engagement element and a second fork-shaped recess for engaging the second engagement element, preferably the two fork-shaped recesses being open to opposite sides and running in opposite directions.

In the motorized actuation capacity of the engagement module, it is important that an optimally configured actuating arrangement is ensured. This can be achieved according to the invention by forming the actuating arrangement with a handle piece that has two essentially elastic actuating segments, wherein the actuation of the actuating segments in any case triggers a motorized function which is assigned to the respective actuating segment.

Other details, features and advantages of this invention are explained in the detailed description below with reference to the accompanying drawings.

### BRIEF DESCRIPTION OF THE DRAWINGS

FIG. 1 schematically depicts a motor vehicle with a sliding door in accordance with the invention,

FIG. 2 shows the sliding door of the invention in the opened position in a sectional view taken along line II-II in FIG. 1,

FIG. 3 shows the sliding door as shown in FIG. 2 in the closed position,

FIG. 4 an enlarged view of a detail of the sliding door as shown in FIG. 2 with the latch in the catch position,

FIG. 5 shows the detail of the sliding door shown in FIG. 3 with the latch in the open position,

FIG. 6 is a sectional view of the actuating arrangement of the sliding door as shown in FIG. 2 and FIG. 3,

FIG. 7 shows the representation from FIG. 4 with a drive of the engagement module in a first embodiment,

FIG. 8 shows the representation from FIG. 7 in a second embodiment,

FIG. 9 shows the representation from FIG. 7 in a third embodiment,

FIG. 10 is a schematic view of the latch and the ratchet of the fixing arrangement in another embodiment when the sliding door is in the opened position,

FIG. 11 shows the representation from FIG. 10 when the sliding door is in the closed position,

FIG. 12 shows the representation from FIG. 10 when the sliding door is in the intermediate position.

### DETAILED DESCRIPTION OF THE INVENTION

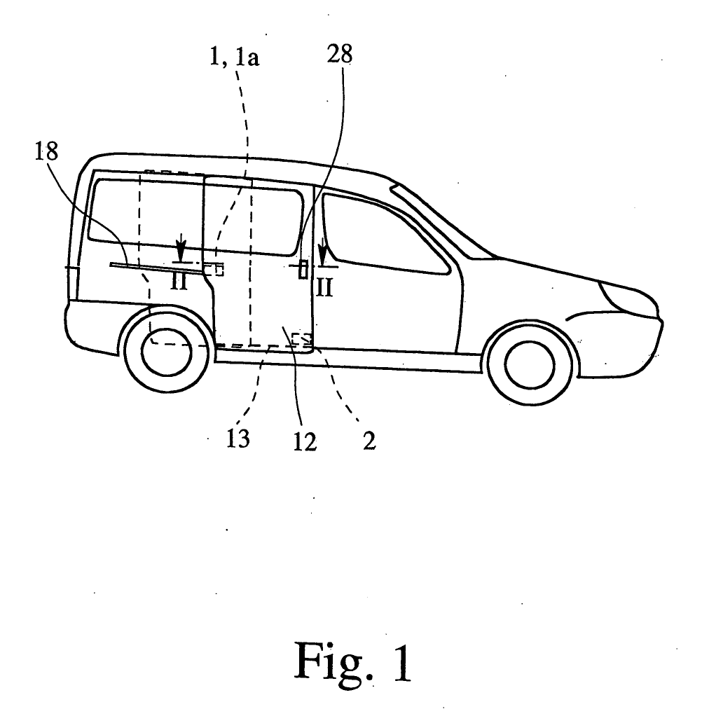

FIG. 1 shows a motor vehicle which is equipped with the sliding door in accordance with the invention. The sliding door can be slid into an opened and into a closed position, and thus, closes the loading and unloading opening of the motor vehicle. For this purpose, the sliding door is rail-guided, as is described in detail below. However, other designs can also be chosen for implementing the desired kinematics of motion of the sliding door.

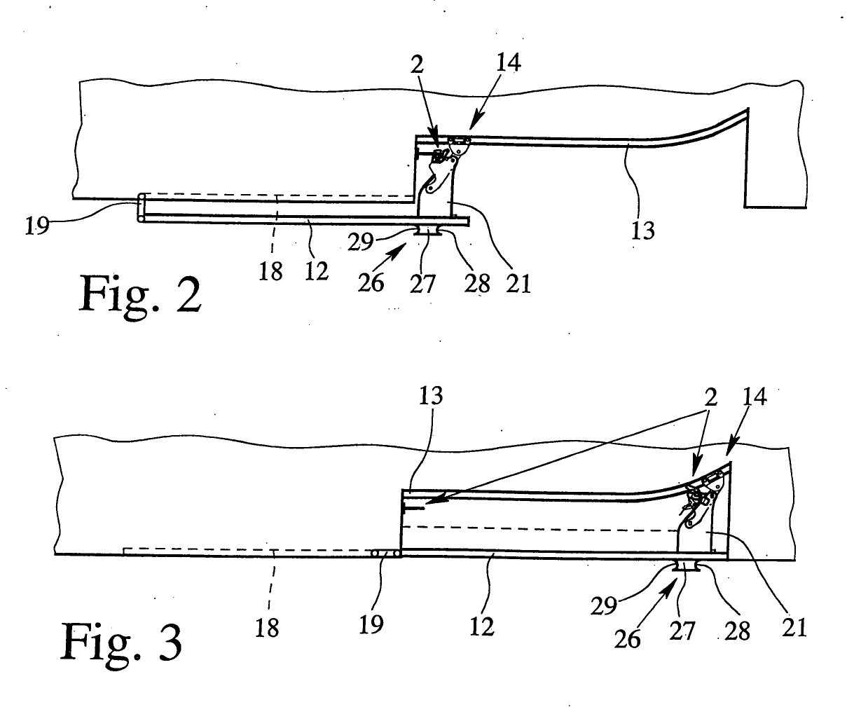

Generally, a sliding door has a motor vehicle lock arrangement 1 by which the sliding door can be fixed and locked in its closed position (FIG. 1, not shown in FIGS. 2, 3). However, it is important here that there is a fixing arrangement 2 with which the sliding door can be fixed in its opened position. The opened position of the sliding door is shown in FIG. 2, and the closed position in FIG. 3.

The fixing arrangement 2 has an engagement module 3, on the one hand, and an engagement element 4, on the other, the engagement module 3 engaging the engagement element 4 when the sliding door is moved into the open position, and in this way, fixing the sliding door in the opened position.

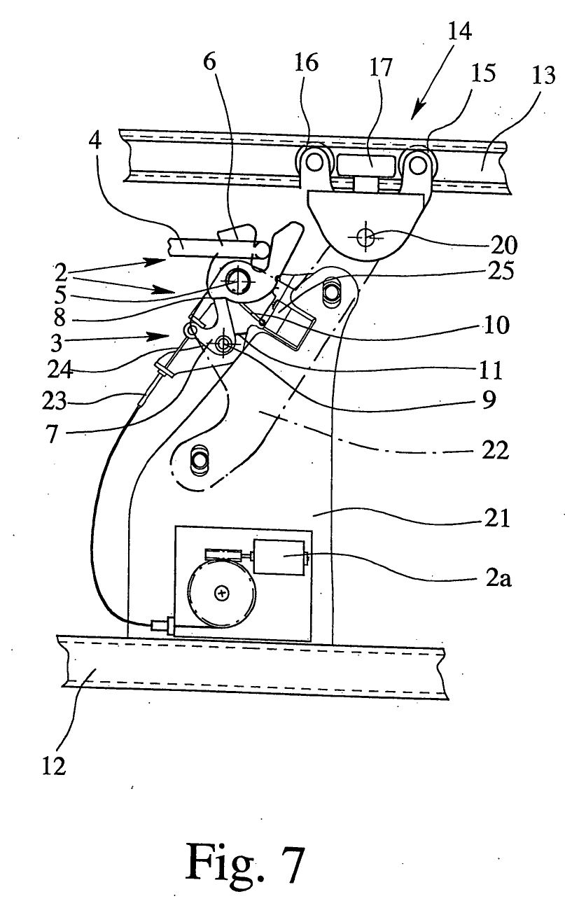

It is now provided that the engagement module 3 can be actuated by a drive in a motorized manner when the sliding door has been fixed in the opened position. The motorized actuation releases the engagement element 4, by which the sliding door can then be moved in the closing direction. Preferred structural configurations for motorized actuation of the engagement module 3 are explained in detail below (the drive is shown only in FIGS. 7-9).

The engagement module 3 preferably has lock elements which are known from the area of motor vehicle locks, specifically a latch 6 which can be pivoted around an axis 5, and a ratchet 7. The latch 6 can, in a conventional manner, be moved between an open position and a catch position, and is held in the catch position by the ratchet 7. In the catch position, the ratchet 7 engages a shoulder 8 which is located on the outer periphery of the latch 6. In a preferred configuration, the ratchet 7 is also supported to pivot around a pivot axis 9.

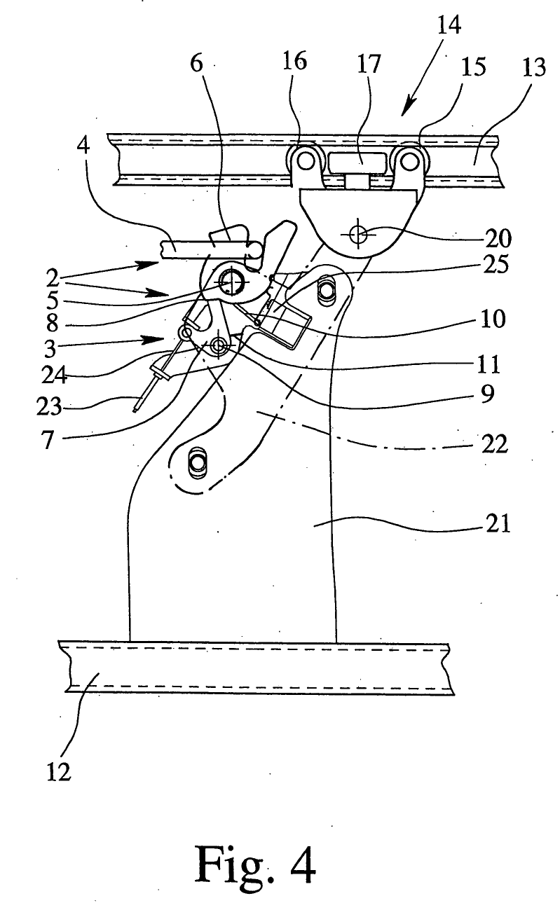

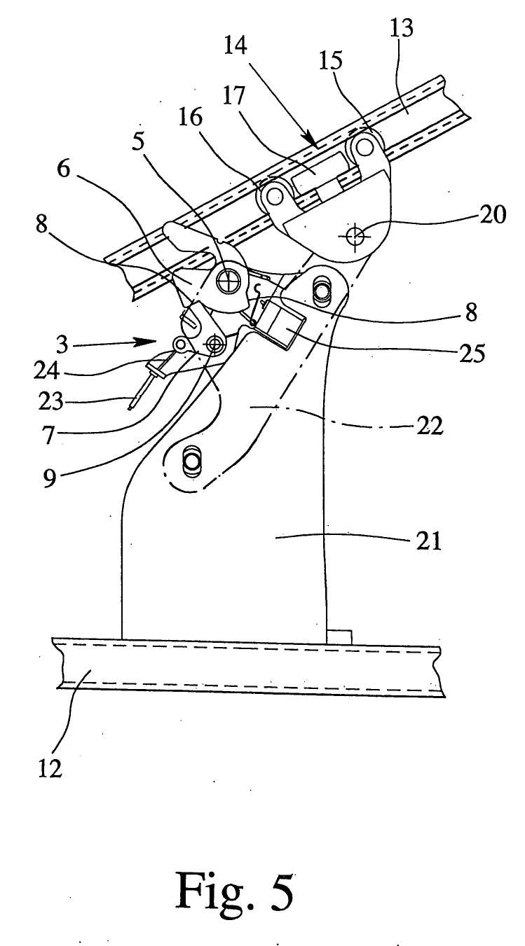

The engagement module 3 and the engagement element 4 are made and arranged such that, when the sliding door is moved into the open position, the latch 6 engages the engagement element 4, and thus, is transferred from the open position into the catch position. FIG. 4 shows the latch 6 in the catch position, FIG. 5 shows the latch 6 in the open position, and in neither figure is the drive shown. FIG. 4 shows that, when the latch 6 is in the catch position, it is not possible to move the sliding door in the closing direction, in FIG. 4 to the right. The sliding door is fixed in its open position.

Numerous versions are conceivable for the structural configuration of the engagement module 3, on the one hand, and of the engagement element 4, on the other hand. The engagement element 4 can be made, for example, as locking clip or as a locking pin with any shape.

The latch 6 is pretensioned into its open position and is kept in the catch position against its pretensioning by the ratchet 7. The ratchet 7 is pretensioned preferably into its catch position, so that it automatically engages when the latch 6 is moved from the open position into the catch position. The aforementioned pretensioning of the latch 6 and the ratchet 7 is implemented preferably by the corresponding springs 10, 11.

In this preferred embodiment, the engagement module 3 with the latch 6 and the ratchet 7 is located on the sliding component 12 of the sliding door. The engagement element 4 is located accordingly on the vehicle body. When the sliding door is moved into the open position, the engagement module 3 approaches the stationary engagement element 4 until the latch 6 engages the engagement element 4, and thus, is swung into the catch position, in FIG. 5 around to the right, by which the ratchet 7 in turn engages.

However, in certain applications, it can also be advantageous for the engagement element 4 to be located on the sliding component 12 of the sliding door and for the engagement module 4 to be stationary. Then, when the sliding door is moved into the opened position, the engagement element 4 moves toward the engagement module 3.

Based on FIGS. 4 & 5, an essential advantage of the suggested approach is noted, specifically, that the safety of fixing sliding door in the opened position is maximized. If, for example, due to the action of an external force, relative movements occur between the sliding component 12 of the sliding door and the vehicle body on which the engagement element 4 is located in the illustrated embodiment, this relates exclusively to the coupling between the latch 6 and the engagement element 4. The blocking action of the ratchet 7, which is decisive for the safety of fixing, is therefore not adversely affected in these relative movements.

It has already been pointed that any constructional implementation of the kinematics of motion of the sliding door can be used here. In this preferred embodiment, the sliding door is guided in an inner guide rail 13, and for this purpose, has a roller arrangement 14. The roller arrangement 14 has two rollers 15, 16, for lateral guidance and another roller 17 for accommodating the weight of the sliding component 12 of the sliding door. The guide rail 13 is located in the bottom area of the loading and unloading opening.

In order to achieve a stable arrangement, according to one advantageous configuration, the same guide rail 13 can be provided in the upper area of the loading and unloading opening. There is preferably an outer guide rail 18 on the outside of the vehicle body which provides for stability, especially when the sliding door is moved into the open position. The coupling between the movable component 12 of the sliding door and the outer guide rail 18 takes place preferably via a pivoting element 19.

The inner guide rail 13 has a section which is curved toward the vehicle interior and which enables “countersinking” of the sliding component 12 of the sliding door, such that the closed sliding door, first of all, on one side, ends flush with the vehicle body. On the other side, the pivoting element 19 provides for the desired flush termination by its pivoting in a corresponding manner into the closed position when the sliding door is moved (compare FIGS. 2 & 3).

Due to the above described curved configuration of the inner guide rail 13, the roller arrangement 14 must be coupled to the sliding component 12 of the sliding door to be able to pivot around a pivot axis 20. This follows from a survey of FIGS. 4 & 5.

The special arrangement of the engagement module 3 is particularly advantageous here. It is specifically such that the engagement module 3 and the roller arrangement 14 are located together on the carrier component 21, and that the sliding component 12 of the sliding door is attached to the carrier component 21. In this embodiment, the roller arrangement 14 is located on the carrier component 21 via an intermediate element 22 which is shown by the dot-dash line. This leads to an especially compact arrangement such that the installation space which is necessary anyway around the roller arrangement 14 is used at the same time for the engagement module 3. The roller arrangement 14 and the engagement module 3 thus form a compact functional unit.

In a preferred configuration, the pivot axis 5 of the latch 6 of the engagement module 3, in the mounted state, is oriented essentially vertically. This can be taken from FIGS. 4 & 5. With it, an especially flat configuration of the engagement module 3 can be achieved.

However, it can also be advantageous to align the pivot axis 5 of the latch 6 of the engagement module 3 in the mounted state essentially horizontally. This can be advantageous, for example, for the arrangement of the engagement element 4.

A series of construction possibilities are possible for lifting the ratchet 7, and thus, releasing the sliding door. In the illustrated preferred embodiment, the ratchet 7 of the engagement module 3 can be raised by a motor by the drive via a Bowden cable 23, and for this purpose, is coupled to the core 24 of the Bowden cable 23. This enables a space-saving and flexible arrangement of the engagement module 3. The drive then engages the ratchet 7 via the Bowden cable 23 (FIG. 7).

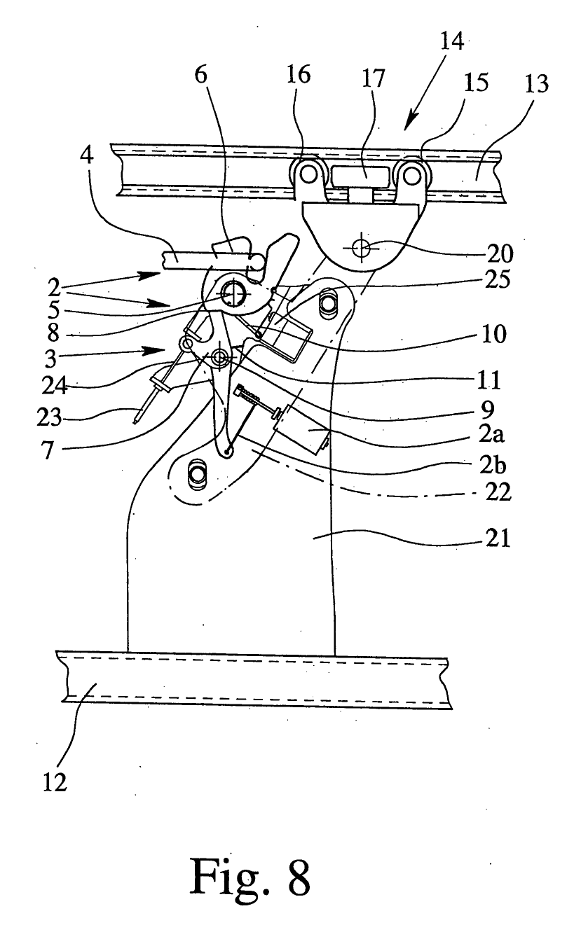

However, the drive can also be located in the immediate vicinity of the ratchet 7 (FIG. 8, 9). Here the “immediate vicinity” means that the drive is coupled to the ratchet 7 via gearing or the like and not, for example, via a remote transmission means or the like. One example of this is the preferred embodiment which is shown in FIG. 8. Here, the drive has a drive motor 2a which is coupled to the ratchet 7 for motorized lifting of the ratchet 7 via a flexible traction mechanism 2b. In one especially preferred configuration, the flexible traction mechanism 2b is a sheathed cable. With it, the development of noise can be greatly reduced in the motorized actuation. At the same time, maintenance of the drive is not a problem since lubricants or the like can be completely eliminated.

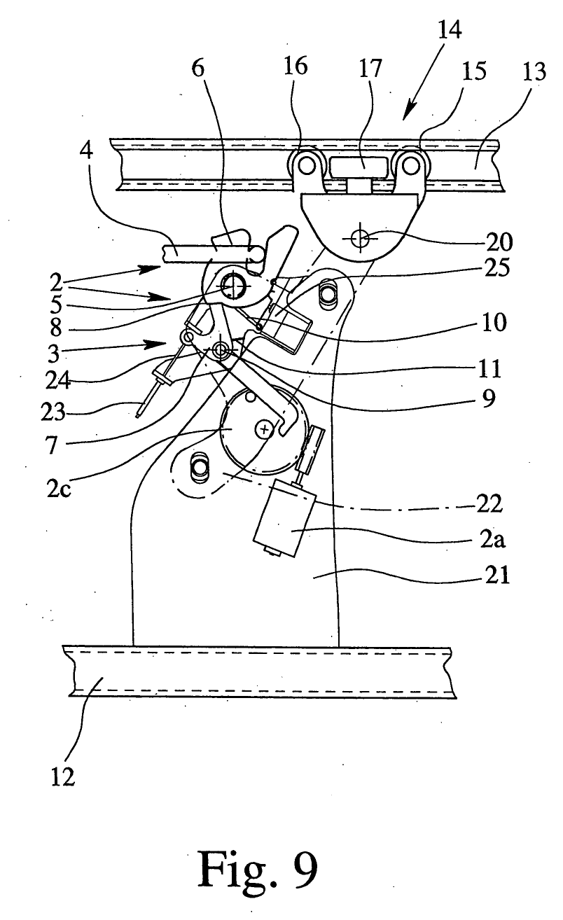

The further preferred embodiment shown in FIG. 9 has a drive with a drive motor 2a and an actuating element 2c. The actuating element 2c can be caused to engage the ratchet 7 for motorized lifting of the ratchet 7. This leads to an especially durable arrangement.

Furthermore, to monitor the fixing function, it is advantageous if the position of the latch 6 is detected by sensor means. For this reason, in a preferred configuration, there is a microswitch 25 which switches into the catch position when the latch 6 is moved.

Generally, the sliding door has a motor vehicle lock arrangement 1 by which the sliding door can be fixed and locked in its closed position. They are the usual functions of a motor vehicle lock arrangement 1 for a closed vehicle door (FIG. 1).

In an especially preferred embodiment, it is now provided that the engagement module 3, therefore the fixing arrangement 2, at least in part, especially the latch 6 of the engagement module 3, is assigned to this motor vehicle lock arrangement 1. This means that the functions of the motor vehicle lock arrangement 1, on the one hand, and of the fixing arrangement 2, on the other, are at least partially combined; this necessarily leads to a compact and economical approach.

In one special configuration, the motor vehicle lock arrangement 1, in the proven manner, has a latch and that the latch of this motor vehicle lock arrangement 1 is the latch 6 of the engagement module 3 of the fixing arrangement 2. For this purpose, there can be another engagement element 4 which engages the engagement module 3 when the sliding door is moved into the closed position.

The motor vehicle lock arrangement 1 can be a manually actuated arrangement. In a preferred configuration, the motor vehicle lock arrangement 1 can be actuated by a motor and/or can be locked and unlocked by a motor.

Another preferred configuration is a two-part motor vehicle lock arrangement which has a main lock arrangement 1a, on the one hand, and an additional locking arrangement, on the other. The sliding door can be fixed as above in the closed position by the main lock arrangement 1a. The additional lock arrangement is used to support the main lock arrangement 1a when the sliding door is fixed in the closed position. It is especially advantageous in this preferred configuration that the fixing arrangement 2, at the same time, provides the additional lock arrangement. Thus, on the one hand, secure fixing of the sliding door in the closed position is ensured. On the other hand, fixing of the sliding door in the opened position is ensured, with minimum constructional effort.

It is especially advantageous that the fixing arrangement 2 for fixing the sliding door in the closed position, on the one hand, and for fixing the sliding door in the opened position, on the other, need not be designed to be especially strong as compared to the main lock arrangement 1a. In this way, the sliding door can be designed altogether optimally such that over-dimensioning is largely prevented. This generally leads to a reduction of production costs.

In one preferred configuration, the fixing arrangement 2 is made such that it can accommodate forces perpendicularly to the direction of travel when the sliding door is in the closed position. This means primarily forces acting perpendicular to the sliding door from the inside to the outside. This configuration is especially advantageous for cases in which articles or even individuals collide with the door while driving. The fixing arrangement 2 then opposes unwanted opening of the sliding door.

An optimum distribution of the holding forces arises in that, when the sliding door is in the closed position, the main lock arrangement 1a and the fixing arrangement 2, viewed in the direction of travel, are located on opposite sides of the sliding door.

Different versions are possible for the height at which the main lock arrangement 1a, on the one hand, and the fixing arrangement 2, on the other, are located on the sliding door. It is especially advantageous and less of a problem to the user according to one preferred configuration in which the main lock arrangement 1a is viewed in the vertical direction is located in the middle area of the sliding door, while the fixing arrangement 2 viewed in the vertical direction is located in the lower area or in the upper area of the sliding door. However, basically, both the main lock arrangement 1 and also the additional lock arrangement 2 can be located in the middle area of the sliding door, viewed in the vertical direction.

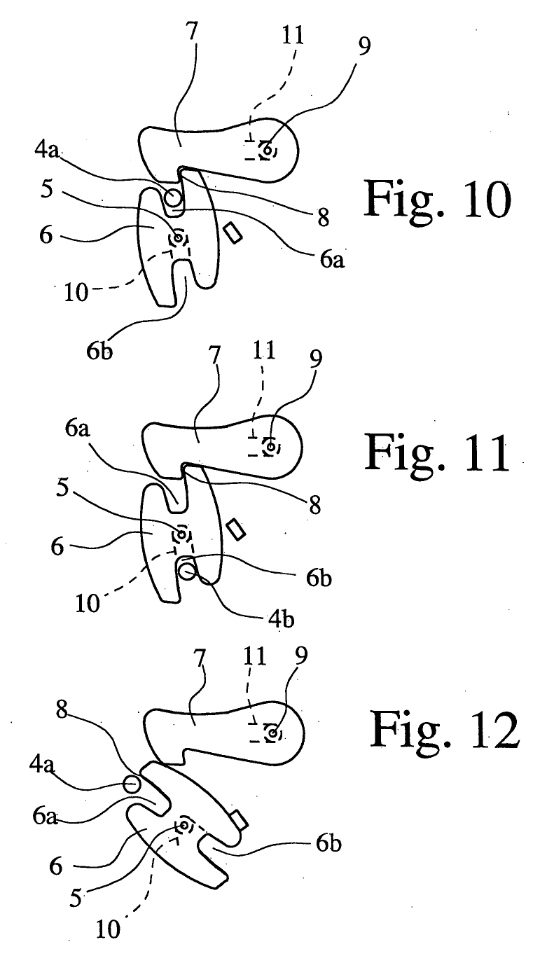

One especially preferred configuration of the latch 6 of the above described multifunctional fixing arrangement 2 is shown in FIGS. 10 to 12. Here, first of all, it is important that the fixing arrangement 2, in addition to the engagement element 4—the first engagement element 4a—has a second engagement element 4b. The engagement module 3 engages the first engagement element 4a when the sliding door is moved into the opened position, and in this way, fixes the sliding door in the opened position, and the engagement module 3 engages the second engagement element 4b when the sliding door is moved into the closed position, and in this way, fixes the sliding door in the closed position. The two engagement elements 4a, 4b are accordingly arranged on opposite sides of the body opening which is closed by the sliding door.

The latch 6 enables engagement with the first engagement element 4a, on the one hand, and the second engagement element 4b, on the other hand. In one preferred configuration, the latch 6 is equipped with a first fork-shaped recess 6a for engaging the first engagement element 4a and with a second fork-shaped recess 6b for engaging the second engagement element 4b. In the preferred embodiment shown in FIGS. 10 to 12, the two fork-shaped recesses 6a, 6b open to opposite sides and run in opposite directions. Here, the pivot axis 5 of the latch 6 is located preferably between the two fork-shaped recesses 6a, 6b. The latch 6 is thus made essentially H-shaped, as is shown in FIGS. 10 to 12. Furthermore, these figures show that the two fork-shaped recesses 6a, 6b each have fork arms of different length. The special advantage of this configuration becomes apparent from the following explanation of how the engagement module 3 works.

When the sliding door is moved into the opened position, in FIG. 3 to the right, the first engagement element 4a engages the first fork-shaped recess 6a (FIG. 12) and presses the latch into the catch position which is shown in FIG. 10. When the sliding door is moved into the closed position, conversely, the second engagement element 4b engages the second fork-shaped recess 6b (FIG. 11) and presses the latch 6 in turn into the catch position. For this purpose, the latch 6 likewise rotates around to the right so that pivoting of the latch 6 when the sliding door is moved into the opened position and into the closed position takes place in the same rotational direction.

In the preferred embodiment, which is shown in FIGS. 10 to 12, when the sliding door is moved into the opened position or into the closed position and upon engagement with the engagement module 3, the two engagement elements 4a, 4b, viewed relative to the engagement module 3, are each located on “imaginary” paths of motion which run past the pivot axis 5 of the latch 6. As shown in FIG. 10, the path of motion which is assigned to the first engagement element 4a runs overhead past the pivot axis 5 of the latch 6. As shown in FIG. 11, the path of motion which is assigned to the second engagement element 4b runs underneath past the pivot axis 5 of the latch 6. This does not mean that the two engagement elements 4a, 4b in fact run past the pivot axis 5. It should simply become apparent that the two engagement elements 4a, 4b are arranged offset to one another in order to ensure that they can engage the respectively assigned fork-shaped recess 6a, 6b.

With the aforementioned explanation, FIG. 12 also clearly shows why the left fork arm of the first fork-shaped recess 6a or the right fork arm of the second fork-shaped recess 6b should be made shorter than the respectively opposite fork arm. This ensures specifically that the two engagement elements 4a, 4b engage the respectively assigned longer fork arm, and thus, press the latch 6 into the catch position. Furthermore, for this reason, it is necessary that the latch 6 be located diagonally with respect to the above described imaginary paths of motion in the open position, as shown in FIG. 12.

With the aforementioned configuration of the latch 6, with respect to the two engagement elements 4a, 4b, the actuation of the latch 6 is completely symmetrical. In the simplest case, the latch 6 is made essentially point-symmetric with respect to its pivot axis 5. This can entail advantages especially with respect to production engineering.

The locking of the latch 6 in the catch position is especially simple and compact in the preferred embodiment shown in FIGS. 10 to 12. For engagement with the ratchet 7, the latch 6 has a catch in the form of a shoulder 8, this shoulder 8 being located on the fork arm of one of the two fork-shaped recesses 6a, 6b. The ratchet 7 can be caused to engage and disengage from the latch 6 by pivoting around its pivot axis 9. Here, it is such that the ratchet 7 engages the longer fork arm of the first fork-shaped recess 6a. Depending on the application, here, there can also be two catches, for example, to implement a preliminary catch and a main catch, as is conventional in known side door locks.

Basically, it can be provided that there are several latches 6 which are located preferably parallel to one another in order to be able to accommodate larger holding forces. However, in an especially preferred configuration, the latch 6 is the sole latch 6 of the engagement module 3.

It is pointed out that, in another preferred embodiment, the main lock arrangement 1a and the additional lock arrangement which is provided by the fixing arrangement 2 can be designed to be equivalent with respect to the distribution of the holding forces.

The above described sliding door can preferably be moved manually. In order to further increase the ease of use, according to another preferred version, it is provided that the sliding door can be moved by a motor. Here, the above described fixing arrangement 2 is advantageous especially in that self-locking of the drive of the sliding door is not necessary for fixing of the sliding door.

In particular, for a sliding door with several of the above described motorized functions, it is especially advantageous that the sliding door has an electrical actuating arrangement 26 and that two motorized functions can be triggered by means of the actuating arrangement 26 in any case.

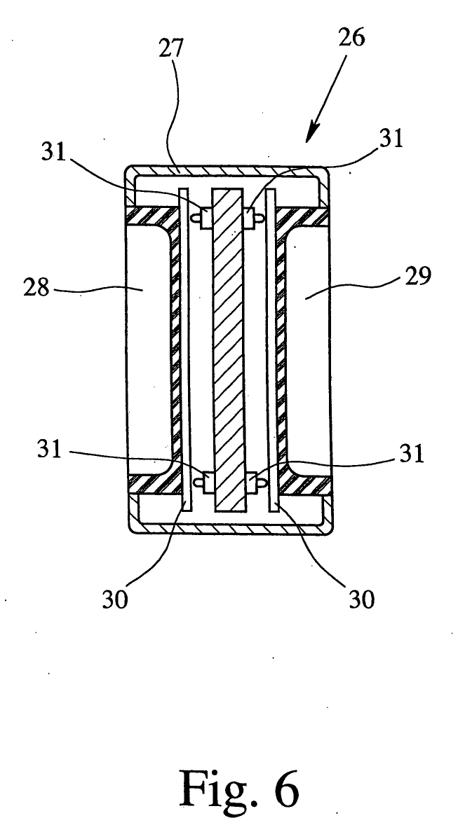

As shown in FIG. 6, the actuating arrangement 26 preferably has a handle piece 27 which in turn is equipped with two essentially elastic actuating segments 28, 29. The actuation of the actuating segments 28, 29, then triggers a motorized function which is assigned to the respective actuating segment 28, 29.

The arrangement of the actuating segments as shown in FIG. 6 is especially advantageous. The two actuating segments 28, 29, viewed in the direction of travel are located on opposing sides of the handle piece 27. According to one preferred version, the function which is assigned to the actuating segment 28 is the motorized actuation of the motor vehicle lock arrangement, and the function which is assigned to the other actuating segment 29 is the motorized actuation of the fixing unit. This leads to an especially intuitive operation since the user must actuate the handle piece 27 only in the direction in which he would ultimately like to move the sliding door.

In the sliding door which can be moved by a motor, preferably, the function which is assigned to actuating segment 28 is the motorized sliding movement of the sliding door in the opening direction and the function which is assigned to the other actuating segment 29 is the motorized sliding movement of the sliding door in the closing direction.

The actuating segments 28, 29, which are integrated into the handle piece 27, are made as rubber insert parts which engage the correspondingly assigned microswitches 31 via transmission elements 30. The handle piece 27 is preferably made in two parts and has a cover which is otherwise clipped to the handle piece 27.

Finally, the handle piece 27 has a plug linkage which, at the same time, with the mechanical mounting of the handle piece 27, ensures the electrical linkage of the actuating arrangement 26.

What is claimed is:

1. Sliding door for a motor vehicle, the sliding door being movable by a sliding motion into an opened and into a closed position, comprising:
a fixing arrangement, the fixing arrangement having an engagement module and an engagement element, the engagement module being adapted to engage the engagement element when the sliding door is moved into the opened position for fixing the sliding door in the opened position,
wherein the engagement module, when the sliding door is been fixed in the opened position, is actuatable by a drive in a motorized manner for releasing the engagement element and enabling the sliding door to be moved toward the closed position.

2. Sliding door for a motor vehicle as claimed in claim 1, wherein the engagement module has a latch which is mounted to pivot around a pivot axis, and a ratchet, wherein the latch is movable between an open position and a catch position, wherein the ratchet is adapted for holding the latch in the catch position, and wherein the latch engages the engagement element when the sliding door is moved into the opened position and is transferred from the open position into the catch position so as to fix the sliding door in the opened position.

3. Sliding door as claimed in claim 1, wherein the engagement module is located on a sliding component of the sliding door and wherein the engagement module is stationary.

4. Sliding door as claimed in claim 3, wherein the sliding door has a roller arrangement that is guided in a guide rail, wherein the engagement module and the roller arrangement are located together on a carrier component, and wherein the sliding component of the sliding door is attached to the carrier component.

5. Sliding door as claimed in claim 2, wherein the pivot axis of the latch of the engagement module is oriented essentially vertically in a mounted state of the sliding door in a vehicle.

6. Sliding door as claimed in claim 2, wherein the ratchet of the engagement module is raisable by the drive via a motor and a Bowden cable, the ratchet being coupled to the core of the Bowden cable.

7. Sliding door as claimed in claim 2, wherein the drive of the fixing arrangement is located in the immediate vicinity of the ratchet.

8. Sliding door as claimed in claim 2, wherein the drive has a drive motor which is coupled to the ratchet for motorized lifting of the ratchet via a flexible traction mechanism.

9. Sliding door as claimed in claim 2, wherein the drive has a drive motor and an actuating element, and wherein the actuating element is engageable with the ratchet for motorized lifting of the ratchet.

10. Sliding door as claimed in claim 1, wherein the sliding door has a motor vehicle lock arrangement by which the sliding door is adapted to be fixed and locked in its closed position, and wherein the engagement module of the fixing arrangement is associated, at least in part, with the motor vehicle lock arrangement.

11. Sliding door as claimed in claim 10, wherein the engagement module has a pivotable latch, and a ratchet, wherein the latch is movable between an open position and a catch position and is adapted to be held in the catch position by the ratchet, wherein the latch is engageable with the engagement element and is transferred from the open position into the catch position when the sliding door is moved into the opened position so as to fix the sliding door in the opened position, and wherein the motor vehicle lock arrangement has a latch and wherein the latch of the motor vehicle lock arrangement is the latch of the engagement module.

12. Sliding door as claimed in claim 10, wherein the motor vehicle lock arrangement has a main lock arrangement by which the sliding door is adapted to be held in the closed position, wherein the motor vehicle lock arrangement has an additional lock arrangement for supporting the main lock arrangement when the sliding door is fixed in the closed position, and wherein the fixing arrangement forms the additional lock arrangement.

13. Sliding door as claimed in claim 12, wherein the fixing arrangement is adapted to accommodate forces perpendicularly to a direction of travel when the sliding door is in the closed position.

14. Sliding door as claimed in claim 12, wherein engagement element is a first engagement element and besides said first engagement element, the fixing arrangement further comprises a second engagement element, wherein the engagement module engages the first engagement element when the sliding door is moved into the opened position for fixing the sliding door in the opened position, and engages the second engagement element when the sliding door is moved into the closed position for fixing the sliding door in the closed position.

15. Sliding door as claimed in claim 2, wherein the latch has a first fork-shaped recess for engaging the first engagement element and a second fork-shaped recess for engaging the second engagement element.

16. Sliding door as claimed in claim 15, wherein the latch has a shoulder for engagement of the ratchet, the shoulder being located on a fork arm of one of the two fork-shaped recesses.

17. Sliding door as claimed in claim 15, wherein the fork-shaped recesses open in opposite directions and extend in opposite directions

18. Sliding door as claimed in claim 1, wherein the sliding door has an electrical actuating arrangement, and wherein two motorized functions are triggerable by the actuating arrangement.

19. Sliding door as claimed in claim 17, wherein the actuating arrangement has a handle piece, wherein the handle piece has two essentially elastic actuating segments, and wherein actuation of the actuating segments is adapted to trigger a respective motorized function which is assigned to each of actuating segments.

20. Sliding door as claimed in claim 19, wherein two actuating segments viewed, in a direction of travel, are located on opposite sides of the handle piece, and wherein the function which is assigned to one actuating segment is the motorized actuation of the motor vehicle lock arrangement and the function which is assigned to the other actuating segment is the motorized actuation of the fixing arrangement.

21. Sliding door as claimed in claim 19, wherein two actuating segments viewed, in a direction of travel, are located on opposite sides of the handle piece, and wherein the function which is assigned to one actuating segment is the motorized sliding movement of the sliding door in the opening direction and wherein the function which is assigned to the other actuating segment is the motorized sliding movement of the sliding door in the closing direction.
